(19) United States
(12) Patent Application Publication
(10) Pub. No.: US 2006/0109378 A1
(43) Pub. Date: May 25, 2006

(54) Apparatus and method for storing and displaying broadcasting caption

(75) Inventors: Se Joon Yang, Incheon (KR); Sung Suk Kang, Incheon (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/282,772

(22) Filed: Nov. 21, 2005

(30) Foreign Application Priority Data
Nov. 19, 2004 (KR) 10-2004-0094981

(51) Int. Cl. H04N 11/00

(52) U.S. Cl. 348/465; 348/468

(57) ABSTRACT

An apparatus and method for storing and displaying broadcasting caption are provided. Caption information extracted from broadcasting signal and video signal are separately managed. The caption information is extracted from broadcasting signals of a real-time broadcasting or reserved program and is decoded. The decoded caption information is created in a file format and stored in a storage medium. The stored caption file is replayed and displayed. The apparatus provides a function of storing a reservation of caption information, a function of selecting a storage medium, and a useful browsing and managing function for caption file. Accordingly, the caption information can be stored, searched, added, deleted, and moved between storage media.

### BACKGROUND OF THE INVENTION

1. Field of the Invention

The present invention relates to an apparatus and method for storing and displaying broadcasting caption.

2. Description of the Related Art

TV receiver capable of displaying text-caption information receives and decodes a composite video signal including text information from a broadcasting station, performing a series of signal-processes for the received signal to display the same.

FIG. 1 illustrates the construction of a TV receiver capable of displaying text information. Here, though description is made mainly for a RF-based TV receiver, a caption information display technology, which will be described below, is applied similarly or in the same manner for a wire-based TV receiver such as a CATV, or terminals having a caption information display function performed in a DMB (digital multimedia broadcasting) receiver.

A TV broadcast signal received from an antenna 100 is inputted into a tuner 102. The tuner 102 selects a channel from a received broadcast signal and delivers a broadcast signal of the selected channel to a video processor 110 and a text information decoder 104. The text information decoder 104 extracts text information included in a broadcast signal, decodes the text information, and outputs a text code and a control code under control of a controller 108. The control code is information determining a position designation code that designates a position on a screen where a caption that corresponds to the text information is to be displayed, a top or bottom caption mode, a text color, a background color, and text attribute. The text code is information for texts to be displayed on the screen. The text information decoder 104 stores the text code representing caption information in a memory region (not shown) that corresponds to the position designation code. Text data outputted through a memory device is converted into an RGB type text. A caption consisting of this text is displayed on a relevant position through a display device 114 via the video processor 110 and a display controller 112 under control of the controller 108.

The controller 108 outputs an on-screen display (OSD) signal according to a user command through a remote controller 106. The video processor 110 processes a TV video signal inputted from the tuner 102, a text OSD signal inputted from the text information decoder 104, and an OSD signal inputted from the controller 108. A video signal processed by the video processor 110 is outputted to the display device 114 under control of the controller 112.

FIG. 2 is a flowchart of a method for using a caption broadcast display function in a general TV receiver. A general caption broadcast display is performed while a user views live broadcasting. A broadcast signal of a channel selected by a user using the remote controller 106 is processed by the tuner 102, the video processor 110, and the display controller 112, and then outputted to the display device 114 (S200). When a user selects a broadcast caption view function using the remote controller 106 while viewing broadcasting (S202), caption information-text information included in the relevant broadcast channel is decoded by the text information (caption) decoder 104 (S204). The decoded broadcast caption information is outputted in the form of a text OSD signal to the display device 114 through the video processor 110 and the display controller 112 (S206).

A method for displaying a broadcast caption in the general broadcast receiver, or a broadcast receiver mounting a function of displaying a broadcast caption, processes a broadcast caption (regardless of whether the broadcast is an analog broadcast or a digital broadcast) in real-time and displays the same simultaneously with audio/video of broadcasting currently being viewed.

### SUMMARY OF THE INVENTION

Accordingly, the present invention is directed to an apparatus and method for storing and displaying a broadcasting caption that substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for storing a broadcasting caption, the method including: extracting caption information from a broadcasting signal; and storing a caption file created using the extracted caption information.

In another aspect of the present invention, there is provided a method for storing a broadcasting caption, the method including: extracting caption information from a broadcasting signal; adding an attribute to the extracted caption information; and creating the caption information and the attribute information in a file format and storing the created file.

In a further another aspect of the present invention, there is provided a method for displaying a broadcasting caption, the method including: searching broadcasting caption files stored in a storage medium; translating a caption file selected from the searched broadcasting caption files; and displaying the translated caption file.

In a still further another aspect of the present invention, there is provided an apparatus for storing a broadcasting caption, the apparatus including: a decoder for decoding caption information extracted from a broadcasting signal; a caption file creator for creating a caption tile using the decoded caption information; and a storage medium for storing the created caption file.

In a still further another aspect of the present invention, there is provided an apparatus for storing and displaying a broadcasting caption, the apparatus including: a translator for translating the format of a caption file stored in a storage medium; and a display device for displaying the translated caption file.

In addition to the broadcasting caption file, the caption attribute information created from the corresponding program is added and stored. Using the attribute information, the caption information can be searched, deleted, and moved between the storage media.

Further, a caption file is created by adding a corresponding program name, channel information, time information, file size, and one or more sample images extracted from the corresponding program as the attribute information of the broadcasting caption file, and then is stored. Using the stored attribute information, the caption information can be searched, deleted, and moved between the storage media.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a related art TV receiver;

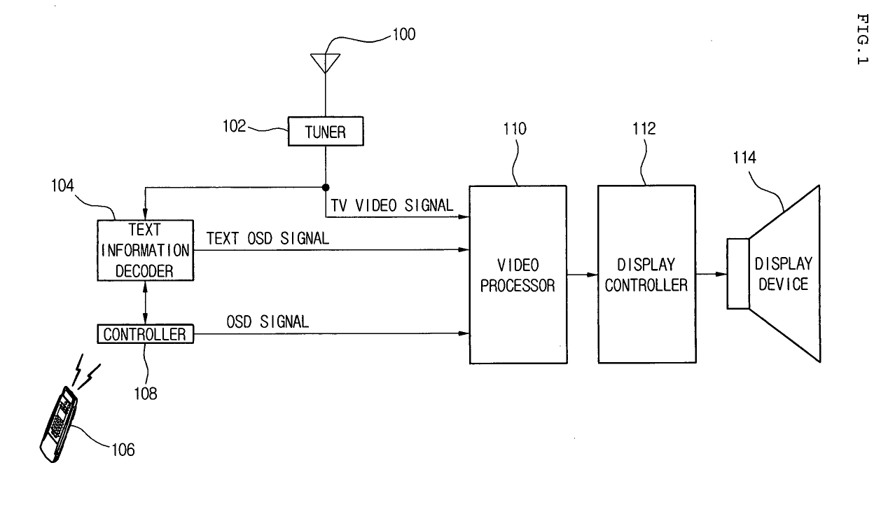

FIG. 2 is a flowchart illustrating a related art method for displaying caption broadcasting;

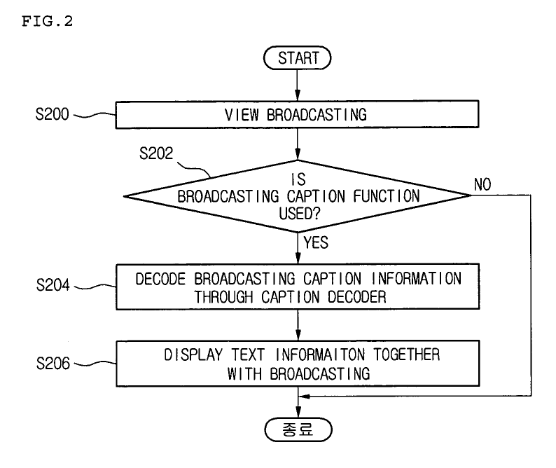

FIG. 3 is a block diagram of a TV receiver according to an embodiment of the present invention;

FIG. 4 is a flowchart illustrating a method for storing and displaying a broadcasting caption according to an embodiment of the present invention;

FIG. 5 is a flowchart illustrating a method for reservedly storing and displaying a broadcasting caption according to an embodiment of the present invention;

FIG. 6 is a diagram illustrating a UI for storing a broadcasting caption by menu OSD according to an embodiment of the present invention;

FIG. 7 is a diagram illustrating a UI for storing a broadcasting caption by using a remote controller according to an embodiment of the present invention;

FIG. 8 is a diagram illustrating a UI for reserving storage of a broadcasting caption by an EPG according to an embodiment of the present invention;

FIG. 9 is a diagram illustrating a UI for managing caption information according to an embodiment of the present invention; and

FIG. 10 is a diagram illustrating a caption information picture according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

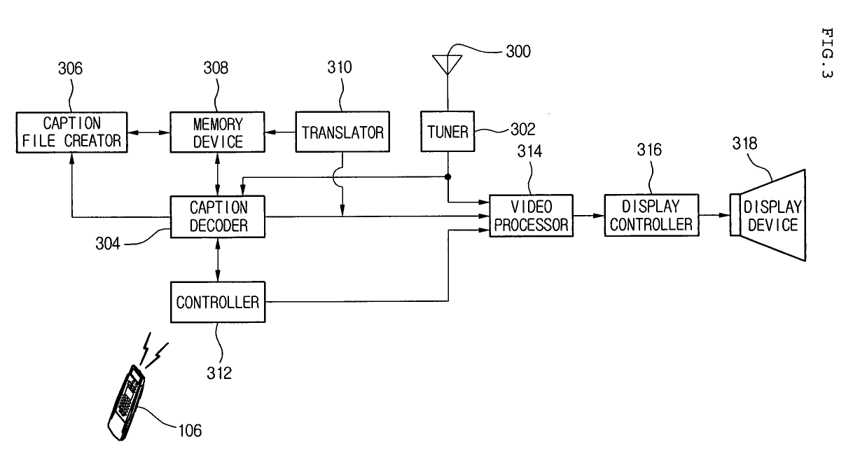

FIG. 3 is a block diagram illustrating an embodiment of a TV receiver according to the present invention. The TV receiver of FIG. 3 extracts and stores broadcast caption information, and reproduces and displays the stored broadcast caption information. The TV exemplified here may be based on an RF or based on a wired broadcast network, or based on both. Also, the TV may be an analog TV broadcast receiver or satellite or ground wave digital TV broadcast receiver. Also, the TV may be a terminal mounting a TV broadcast receiving function therein.

The TV receiver according to an embodiment of the present invention includes an antenna 300, a tuner 302 for selecting a channel, a caption decoder 304 for decoding broadcast caption information included in a broadcast signal of the channel selected by the tuner 302, a caption file creator 306 for creating a file using caption information decoded by the caption decoder 304, a memory device 308 for storing the caption information, a translator 310 for displaying the caption information stored in the memory device 308 on the basis of an OSD, a remote controller 106 for manipulating the apparatus, a controller 312 for controlling storing/reproducing/displaying of the caption information, a video processor 314 for processing a broadcast signal and/or caption information of a channel selected by the tuner 302, a display controller 316 for displaying a broadcast signal and/or caption information processed by the video processor 314, and a display device 318.

The tuner 302 selects and outputs a broadcast signal of a channel selected by a user from broadcast signals received through the antenna 300. The broadcast signal of the channel selected by the tuner 302 is inputted into the video processor 314. The video processor 314 appropriately signal-processes the inputted broadcast signal, makes a video signal that can be displayed, and outputs the same. The display controller 316 outputs the video signal from the video processor 314 to the display device 318.

The caption decoder 304 decodes text information, i.e., caption information included in a broadcast signal of the channel selected by the tuner 302. The caption information decoded by the caption decoder 304 is created as a file and stored in the memory device 308. Here, the type of the caption file may be determined as a default, or selectively designated by a user. For example, the caption file may be stored in a ‘text’ format or an ‘xml’ format. The caption file creator 306 creates the caption file using the caption information decoded by the caption decoder 304, and stores the caption file in the memory device 308. When creating the caption file using the caption information, the caption file creator 306 can store together at least one of attribute information that correspond to that caption information such as a program title, a channel, a date, time information, and a size. Also, a sample image extracted from the program that corresponds to the caption information can be stored together as the file attribute. For example, a sample image of a thumbnail type can be selected and stored together with the caption information. When one caption file corresponds to one program, the sample image may use one thumbnail image, or two or more thumbnail images. In the case where two or more thumbnail images are used, caption displayed on one screen may be used in unit of one scene, or images extracted by a fixed or variable time interval may be used in accordance with the progression of the caption.

The memory device 308 is a medium for storing the caption information. The memory device 308 may be a memory device built in the apparatus, or may be a mobile storage medium. A medium in which the caption information-caption file is to be stored may be determined as a default, or may be designated from an internal memory device and a mobile storage medium by selection of a user. Here, the internal memory device may be a semiconductor memory device or may be a storage medium such as a hard disk drive (HDD). The mobile storage medium also may be a semiconductor memory device or may be a storage medium such as an HDD. A memory card type storage medium can be used, of course.

The translator 310 is a file format converter. The translator 310 is particularly useful when reproducing and displaying caption information stored in a designated predetermined file format. For example, when format-converting a file stored in an ‘xml’ format in the memory device 308 into a format appropriate for a TV OSD so that a TV having no ‘xml’ viewer may provide the caption information to a user, the translator 310 is useful.

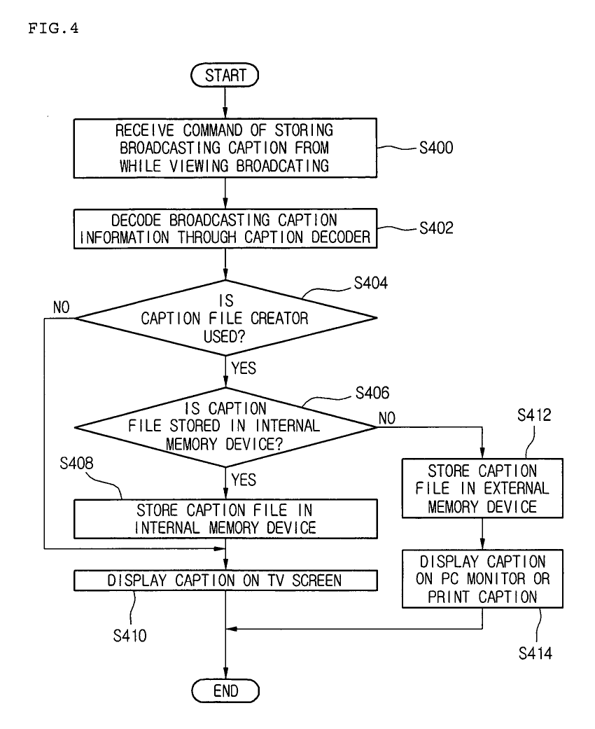

FIG. 4 illustrates a method for storing and outputting caption information according to the present invention. Referring to FIG. 4, a method for performing storing/displaying of a broadcasting caption viewed in real-time is exemplarily illustrated.

While broadcasting is viewed, broadcasting caption information is inputted by a user (S400). A storing command for the broadcasting caption information may be inputted using the remote controller 106. When the storing command for the broadcasting caption information is inputted, the caption decoder 304 extracts and decodes the broadcasting caption information (S402). The caption information decoded by the caption decoder 304 is delivered to the caption file creator 306 and the video signal processor 314. Next, whether to use the caption file creator 306 is judged (S404). The operation S404 is an operation that determines whether to create a caption file using the decoded broadcast caption information or whether to only display the decoded broadcast caption information on a TV screen without storing the information.

When the caption file is not to be created as a result of the operation S404, the caption information is not stored and only the displaying of the caption information is performed (S410).

When the caption file is to be created as a result of the operation S404, an operation S406 of selecting a storage medium is performed. The operation S406 is an operation of judging whether to select an internal memory or an external memory-mobile storage for a storage medium. The selection of the storage medium may be determined in advance as a default, or may be selected and designated in advance by a user, or may be directly selected and designated at the operation S406 by a user. In the case of storing the caption file in the internal memory, the caption file is stored in the internal memory (S408). In the case of storing the caption file in the external memory, the caption file is stored in the external memory (S412). When the caption file is based on a mobile storage medium, the caption file stored in the external memory may be reproduced at a personal computer (PC) and displayed on a monitor, for example, or may be printed using a printer (S414).

The caption file creator 306 is intended for efficiently using the caption information. The caption file creator 306 stores file attribute information such as a program title, a sample image (thumbnail), a channel, a date, a time, a size together with the caption information extracted through the caption decoder 304, and crates a file in a ‘txt’ format or ‘xml’ format. The ‘txt’ format file has a small file size and thus has advantages of conveniently securing a storage space and conveniently copying and moving a file. On the contrary, the ‘xml’ format file has advantages of easily searching items using file attribute information and file contents. When the thumbnail and the caption information synchronized thereto are provided simultaneously, a user can use caption information having enhanced visual recognition by viewing a sample image of a relevant frame.

FIG. 3 is a block diagram illustrating an embodiment of a TV receiver according to the present invention. The TV receiver of FIG. 3 extracts and stores broadcast caption information, and reproduces and displays the stored broadcast caption information. The TV exemplified here may be based on an RF or based on a wired broadcast network, or based on both. Also, the TV may be an analog TV broadcast receiver or satellite or ground wave digital TV broadcast receiver. Also, the TV may be a terminal mounting a TV broadcast receiving function therein.

The TV receiver according to an embodiment of the present invention includes an antenna 300, a tuner 302 for selecting a channel, a caption decoder 304 for decoding broadcast caption information included in a broadcast signal of the channel selected by the tuner 302, a caption file creator 306 for creating a file using caption information decoded by the caption decoder 304, a memory device 308 for storing the caption information, a translator 310 for displaying the caption information stored in the memory device 308 on the basis of an OSD, a remote controller 106 for manipulating the apparatus, a controller 312 for controlling storing/reproducing/displaying of the caption information, a video processor 314 for processing a broadcast signal and/or caption information of a channel selected by the tuner 302, a display controller 316 for displaying a broadcast signal and/or caption information processed by the video processor 314, and a display device 318.

The tuner 302 selects and outputs a broadcast signal of a channel selected by a user from broadcast signals received through the antenna 300. The broadcast signal of the channel selected by the tuner 302 is inputted into the video processor 314. The video processor 314 appropriately signal-processes the inputted broadcast signal, makes a video signal that can be displayed, and outputs the same. The display controller 316 outputs the video signal from the video processor 314 to the display device 318.

The caption decoder 304 decodes text information, i.e., caption information included in a broadcast signal of the channel selected by the tuner 302. The caption information decoded by the caption decoder 304 is created as a file and stored in the memory device 308. Here, the type of the caption file may be determined as a default, or selectively designated by a user. For example, the caption file may be stored in a ‘text’ format or an ‘xml’ format. The caption file creator 306 creates the caption file using the caption information decoded by the caption decoder 304, and stores the caption file in the memory device 308. When creating the caption file using the caption information, the caption file creator 306 can store together at least one of attribute information that correspond to that caption information such as a program title, a channel, a date, time information, and a size. Also, a sample image extracted from the program that corresponds to the caption information can be stored together as the file attribute. For example, a sample image of a thumbnail type can be selected and stored together with the caption information. When one caption file corresponds to one program, the sample image may use one thumbnail image, or two or more thumbnail images. In the case where two or more thumbnail images are used, caption displayed on one screen may be used in unit of one scene, or images extracted by a fixed or variable time interval may be used in accordance with the progression of the caption.

The memory device 308 is a medium for storing the caption information. The memory device 308 may be a memory device built in the apparatus, or may be a mobile storage medium. A medium in which the caption information-caption file is to be stored may be determined as a default, or may be designated from an internal memory and a mobile storage medium by selection of a user. Here, the internal memory may be a semiconductor memory device or may be a storage medium such as a hard disk drive (HDD). The mobile storage medium also may be a semiconductor memory device or may be a storage medium such as an HDD. A memory card type storage medium can be used, of course.

The translator 310 is a file format converter. The translator 310 is particularly useful when reproducing and displaying caption information stored in a designated predetermined file format. For example, when format-converting a file stored in an ‘xml’ format in the memory device 308 into a format appropriate for a TV OSD so that a TV having no ‘xml’ viewer may provide the caption information to a user, the translator 310 is useful.

FIG. 4 illustrates a method for storing and outputting a caption information according to the present invention. Referring to FIG. 4, a method for performing storing/displaying of a broadcasting caption viewed in real-time is exemplarily illustrated.

While broadcasting is viewed, broadcasting caption information is inputted by a user (S400). A storing command for the broadcasting caption information may be inputted using the remote controller 106. When the storing command for the broadcasting caption information is inputted, the caption decoder 304 extracts and decodes the broadcasting caption information (S402). The caption information decoded by the caption decoder 304 is delivered to the caption file creator 306 and the video signal processor 314. Next, whether to use the caption file creator 306 is judged (S404). The operation S404 is an operation that determines whether to create a caption file using the decoded broadcast caption information or whether to only display the decoded broadcast caption information on a TV screen without storing the information.

When the caption file is not to be created as a result of the operation S404, the caption information is not stored and only the displaying of the caption information is performed (S410).

When the caption file is to be created as a result of the operation S404, an operation S406 of selecting a storage medium is performed. The operation S406 is an operation of judging whether to select an internal memory or an external memory-mobile storage for a storage medium. The selection of the storage medium may be determined in advance as a default, or may be selected and designated in advance by a user, or may be directly selected and designated at the operation S406 by a user. In the case of storing the caption file in the internal memory, the caption file is stored in the internal memory (S408). In the case of storing the caption file in the external memory, the caption file is stored in the external memory (S412). When the caption file is based on a mobile storage medium, the caption file stored in the external memory may be reproduced at a personal computer (PC) and displayed on a monitor, for example, or may be printed using a printer (S414).

The caption file creator 306 is intended for efficiently using the caption information. The caption file creator 306 stores file attribute information such as a program title, a sample image (thumbnail), a channel, a date, a time, a size together with the caption information extracted through the caption decoder 304, and crates a file in a ‘txt’ format or ‘xml’ format. The ‘txt’ format file has a small file size and thus has advantages of conveniently securing a storage space and conveniently copying and moving a file. On the contrary, the ‘xml’ format file has advantages of easily searching items using file attribute information and file contents. When the thumbnail and the caption information synchronized thereto are provided simultaneously, a user can use caption information having enhanced visual recognition by viewing a sample image of a relevant frame.

Caption information stored in the internal memory device or the external memory device in a file format is displayed according to user's selection. When the caption file stored in the memory device is replayed, the translator 310 may be used. The translator 310 translates the caption file stored in an xml format into a predetermined format adaptable for displaying it on a TV OSD. Even in the case of TV with no xml viewer, the broadcasting caption information can be provided to the user. That is, the broadcasting caption file can be converted and viewed on a TV screen based on an OSD.

The determination of storing the caption information of a broadcasting currently viewed in real time and the selection of a storage medium and storage path can be performed at a time. This method will be described later. The above-described operation S410 of displaying the caption is performed only when the user wants to view the caption, that is, when the caption view function is on, and otherwise, the caption need not be displayed.

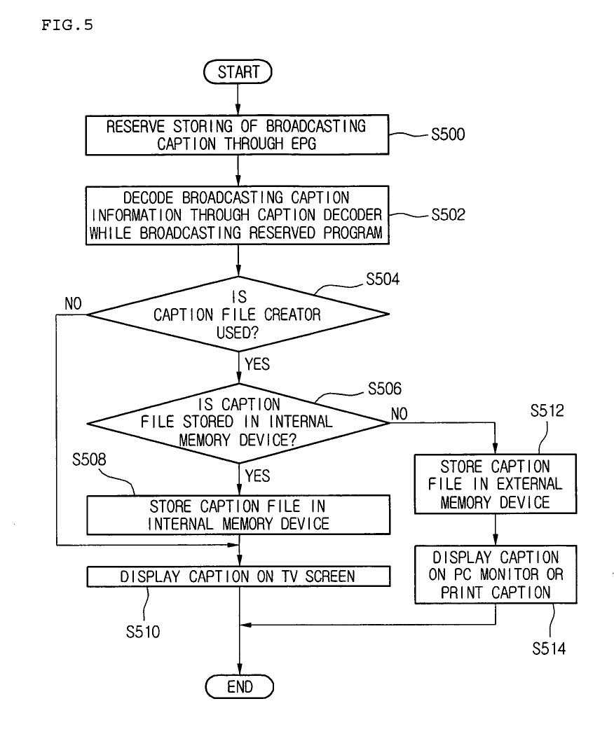

FIG. 5 is a flowchart illustrating a method for reserving to store the broadcasting caption and displaying the same according to an embodiment of the present invention. Specifically, FIG. 5 illustrates a method for reserving to store the broadcasting caption and executing the reservation using an electronic program guide (EPG). The reservation to store the broadcasting caption can be implemented based on the EPG, or can be implemented using a recording reservation based on the OSD. In addition, it is apparent that the reservation of the present invention is based on a technical basis substantially equal to the method for reserving the storing of the caption based on the EPG, which will be described later.

Since the EPG provides information on the broadcasting program, the user selects a ‘caption recording reservation’ button to reserve the recording of a specific based on the EPG (S500). When it is time to broadcast the reserved program, the caption decoder 304 extracts the broadcasting caption information from the caption decoder 304 and decodes the extracted broadcasting caption information (S502). The caption information decoded by the caption decoder 304 is transmitted to the caption file creator 306 and the video processor 314. It is determined whether or not the caption file creator 306 is used (S504). That is, it is determined if the decoded broadcasting information is created in a file format and stored, or if the decoded broadcasting information is only displayed on a TV screen without being stored.

When the caption file is not created, the caption information is only displayed without being stored (S510). Meanwhile, since the storing of the caption has been already reserved, the determination may not be substantially meaningless. However, this is considered because the storing of the caption for the reserved program may be cancelled. When the caption file is created, a storage medium is selected (S506). It is determined which one of an internal memory and an external memory-portable storage medium is used as the storage medium. The selection of the storage medium may be previously set as a default, or may be previously set by the user's selection, or can be set by a direct selection in this operation. When the internal storage medium is selected, the caption file is stored in the internal memory device (S508). When the external storage medium is selected, the caption file is stored in the external memory device (S512). When the portable storage medium is selected, the caption file stored in the external memory device can be reproduced and displayed on a PC monitor, or can be printed through a printer (S514).

The caption file creator 306 is provided for efficiently use the caption information. The caption file creator 306 stores the caption information extracted through the caption decoder 304 together with the caption contents and the file attribute information, such as corresponding program name, sample image (e.g., Thumbnail), channel, date, time, and size, and generates a txt format file or xml format file. The caption file store in the txt format has an advantage in that a file size can be reduced so that it is convenient to secure the storage space and copy and move the file. The caption file stored in the xml format has an advantage in that it is easy to search the file attribute information and file contents. If the caption information synchronized with the Thumbnail is provided, the user can make use of the caption information with a visually improved recognition while viewing a sample image of a corresponding frame.

The caption file stored in the internal or external memory device is replayed according to the user's selection, which will be described later. When replaying the caption file stored in the memory device, the translator 310 can be used. The

The translator 310 translates the caption file stored in an xml format into a predetermined format adaptable for displaying it on a TV OSD. Even in the case of TV with no xml viewer, the broadcasting caption information can be provided to the user. That is, the broadcasting caption file can be converted and viewed on a TV screen based on an OSD.

When reserving the caption, the selections of a target program and a storage medium-storage path can be performed at a time. This method will be described later. The above-described operation S410 of displaying the caption is performed only when the user wants to view the caption, that is, when the caption view function is on, and otherwise, the caption need not be displayed.

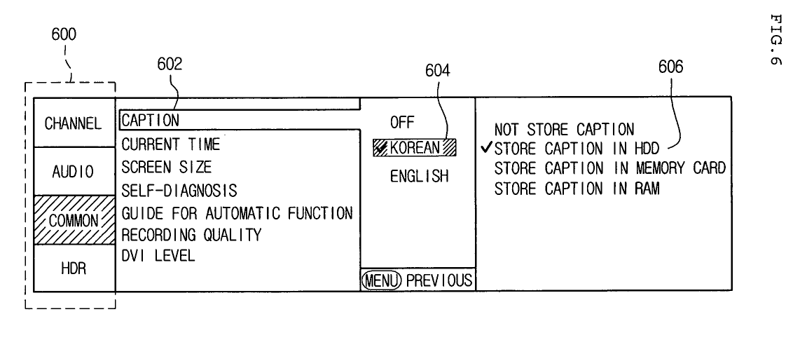

FIGS. 6 to 10 are exemplary diagrams of pictures provided through a user interface (UI) when performing a caption information management, for example, the storing and replaying of the broadcasting caption information. The pictures are merely exemplary and the present invention is not limited to them.

FIG. 6 is an exemplary diagram of a user interface for determining whether to view the caption broadcasting based on the OSD, selecting a language, selecting whether to store the caption, or selecting the storage medium. A main item 600 of a main picture includes a caption broadcasting item 602. Also, the caption broadcasting item 602 includes an item 604 related to a caption broadcasting on and a language selection. If the language is selected, there is provided an item 606 related to the storage of the caption and the storage path, that is, the selection of the storage medium. FIG. 6 illustrates the case where Korean is selected as the language of the caption broadcasting and HDD is selected as the storage medium.

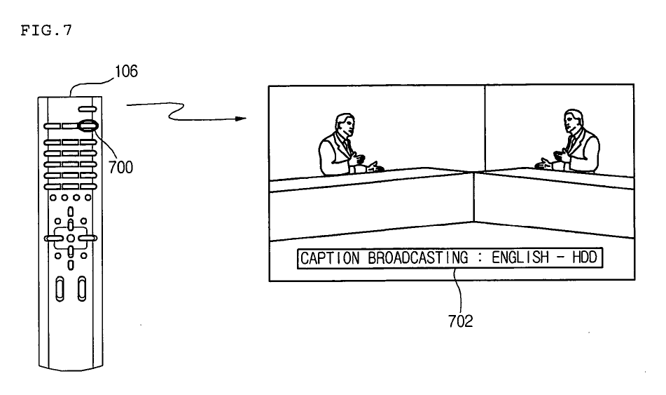

FIG. 7 is an exemplary diagram of the user interface in the method for storing the broadcasting caption using a remote controller. Using a caption broadcasting key 700 assigned to the remote controller 106 while viewing the broadcasting, the serviced caption information is selected, and whether to store the caption is selected. Also, the storage medium is selected. The successive press of the caption broadcasting key 700 can select desired items, such as ‘caption broadcasting: Off’, “caption broadcasting: English: Not store’, ‘caption broadcasting: English: Store in HDD’ 702, and ‘Caption broadcasting: English: Store in memory card’. When ‘caption broadcasting: English: Store in HDD’ 702 is selected, information of ‘caption broadcasting: English: Store in HDD’ is displayed in a lower portion of the broadcasting picture.

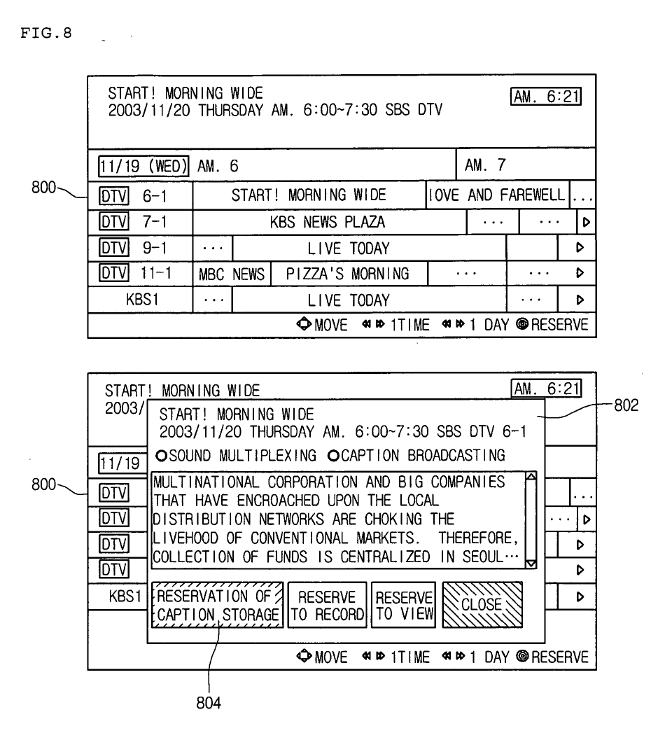

FIG. 8 is a diagram illustrating a UI for reserving storage of a broadcasting caption by an EPG according to an embodiment of the present invention. Specifically, FIG. 8 illustrates an example of a UI picture for reservedly storing a broadcasting caption by using an EPG.

Referring to FIG. 8, a caption storage reservation is performed by selecting a program 802 to be reserved form a channel-program item 800 of an EPG screen. At this point, it is more favorable to users that a “caption storage reservation button” 804 is set to be enabled only when the selected program is a program that services caption broadcasting. When the program is selected and a reservation button 804 is pressed, the caption storage reservation for the corresponding program is completed. At the time of broadcasting of the reserved program, the caption storage is performed on the corresponding program according to the method illustrated in FIG. 5. If the standby power is supplied to the TV receiver even when the TV is not viewed, the power is supplied to the necessary elements (e.g., the tuner, the decoder, the caption file generator, and the memory device) at the time of the caption storage reservation to store the caption information of the corresponding program.

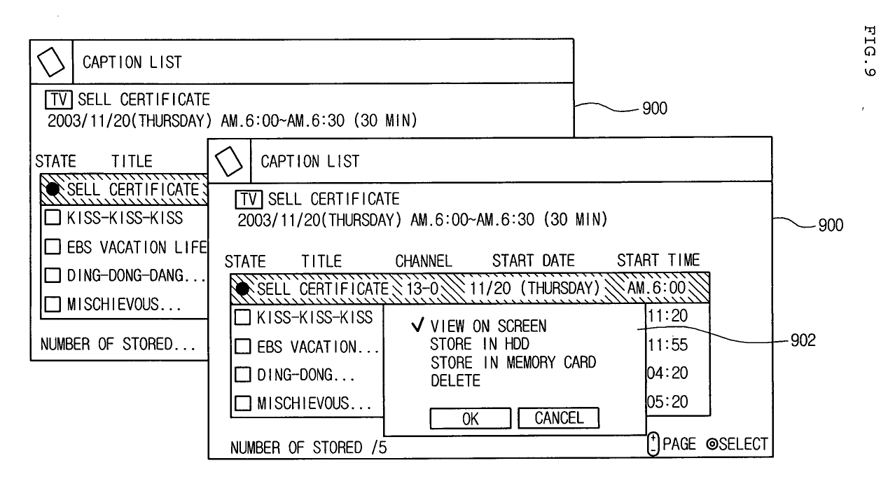

FIG. 9 is a diagram illustrating a UI for managing caption information according to an embodiment of the present invention. Specifically, FIG. 9 is an example of a UI picture illustrating a method for managing the caption information.

Referring to FIG. 9, provided is the UI for selecting whether or not to perform a view on screen mode at the time of the caption information storage or the pre-stored caption information display and managing the inter-medium movement or deletion of the pre-stored caption information, as illustrated in FIG. 4 or 5. A caption file list 900 and a management item 902 for the selected file are provided. The caption file is managed by the controller 312, and the management data are stored in the memory device. When a caption file is generated by the caption file generator 306, data about a program title, channel, time data and size and a storage medium are added to the list to be managed.

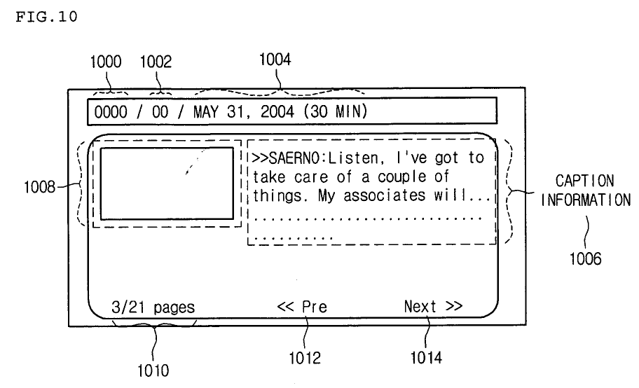

FIG. 10 is a diagram illustrating a caption information picture according to an embodiment of the present invention.

Referring to FIG. 10, the caption information selected from the caption management list illustrated in FIG. 9 is displayed on the screen. According to the user's manipulation and the consequent control operation of the controller 312, a caption file selected form the internal or external memory device is translated by the translator 310, and the translated caption file is outputted to the display device 318 through the video processor 314 and the display controller 316. The caption information picture includes a program title 1000, a channel 1002, time data 1004, caption information 1006, a sample image 1008, the number of pages 1010, and page conversion keys 1012 and 1014.

The sample image 1008 is stored in synchronization with the caption information 1006. Also at the time of display, the proper sample image is synchronized and displayed according to the page conversion. The sample image may be in one-to-one correspondence with the caption file. Alternatively, the sample image may be properly extracted from the corresponding program on a page basis or on a few pages basis, and the extracted sample image may be stored and displayed in association of the corresponding caption information.

According to the present invention, it is possible to store and manage the caption information in a separate file from that of the video data during the TV viewing of analog or digital broadcasting and to freely use the stored caption information in other displays such as TVs or PCs. Also, it is possible to reserve to store only the caption of the desired program. Also, the caption information can be managed to include the file attribute information (such as channels, dates, time, and sizes) and the data representing the caption content, as well as the caption content. Also, the data representing the caption information, for example, the sample image (such as Thumbnail) and the synchronized caption information are simultaneously provided at the time of the display of the caption information file. Also, it is possible to select the place-storage medium for storing the caption information, designate the file format for storing the caption information, and provide the file conversion function necessary for the display operation. Also, it is possible to provide the UI favorable to the caption file search operation, the copy operation between the storage mediums, and the file addition and deletion operations.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for storing a broadcasting caption, the method comprising:
extracting caption information from a broadcasting signal; and
storing a caption file created using the extracted caption information.

2. The method according to claim 1, further comprising selecting a storage medium during the storing of the caption file.

3. The method according to claim 1, wherein the storage of the caption information is real-time storage of a viewing program or storage of a caption for a reserved program.

4. The method according to claim 1, further comprising designating the type of the caption file.

5. A method for storing a broadcasting caption, the method comprising:
extracting caption information from a broadcasting signal;
adding an attribute to the extracted caption information; and
creating the caption information and the attribute information in a file format and storing the created file.

6. The method according to claim 5, wherein the attribute of the caption information includes at least one of a program title, a channel, time data, and a file size.

7. The method according to claim 5, wherein the attribute of the caption information includes an image selected from a corresponding broadcasting program.

8. The method according to claim 5, wherein the storage of the caption information is real-time storage of a viewing program or storage of a caption for a reserved program.

9. The method according to claim 5, further comprising designating the type of the caption file.

10. A method for displaying a broadcasting caption, the method comprising:
searching broadcasting caption files stored in a storage medium;
translating a caption file selected from the searched broadcasting caption files; and
displaying the translated caption file.

11. The method according to claim 10, wherein a file attribute for searching the caption file is provided.

12. The method according to claim 10, further comprising providing at least one of a title, channel, time data and size with respect to the corresponding broadcasting program as a file attribute for the searching of the caption file.

13. The method according to claim 10, further comprising providing an image selected from the corresponding broadcasting program as an attribute for the searching of the caption file.

14. The method according to claim 10, further comprising performing addition, deletion, inter-medium movement on the searched caption file.

15. An apparatus for storing a broadcasting caption, the apparatus comprising:
a decoder for decoding caption information extracted from a broadcasting signal;
a caption file creator for creating a caption tile using the decoded caption information; and
a storage medium for storing the created caption file.

16. The apparatus according to claim 15, wherein the storage medium is a built-in type or a portable type.

17. The apparatus according to claim 15, wherein the caption file creator adds at least one of program title, channel, time data and size with respect to a caption file to the corresponding caption tile as a file attribute to create the caption file.

18. The apparatus according to claim 15, wherein the caption file creator adds at least one or more sample images selected from the corresponding program to the caption file as an file attribute to create the caption file.

19. An apparatus for storing and displaying a broadcasting caption, the apparatus comprising:
a decoder for decoding caption information extracted from a broadcasting signal;
a caption file creator for creating a caption tile using the decoded caption information;
a storage medium for storing the created caption file;
a translator for translating the format of the stored caption file in the storage medium; and
a display device for displaying the translated caption file.

20. The apparatus according to claim 19, wherein at least one of program title, channel, time data and size for a caption file is added to the corresponding caption tile as a file attribute to create and store the caption file.

21. The apparatus according to claim 19, wherein the caption file creator adds at least one or more sample images selected from the corresponding program to the caption file as an file attribute to create and store the caption file.

22. A method for storing a broadcasting caption, the method comprising:
performing a caption setting storage operation on the basis of reserved or real-time storage of broadcasting caption information;
extracting the caption information of the set program;
creating attribute information for the corresponding program with respect to the extracted caption information; and
storing the attribute information and a caption file created using the caption information.

23. The method according to claim 22, wherein the storage reservation of the broadcasting caption information is performed on the basis of an EPG (electronic program guide).

24. The method according to claim 22, wherein the attribute information is an image extracted from a program corresponding to the caption information.

25. The method according to claim 22, wherein the creating of the attribute information is performed by a caption page in a program corresponding to the caption information, or is performed by making images extracted on a caption time basis correspond to each of the corresponding caption information.
